(19) United States
(12) Patent Application Publication
(10) Pub. No.: US 2011/0077347 A1
(43) Pub. Date: Mar. 31, 2011

(54) POLYMER BLEND FILMS FOR CHEMICALLY PROTECTIVE ARTICLES

(75) Inventor: Nicole M. Reinartz, Wilmington, DE (US)

(73) Assignee: E. I. DU PONT DE NEMOURS AND COMPANY, Wilmington, DE (US)

(21) Appl. No.: 11/764,987

(22) Filed: Jun. 19, 2007

(51) Int. Cl. C08L 39/02; C08L 81/06; C08L 71/10; C08L 39/04; C08L 27/12

(52) U.S. Cl. 524/508; 525/189; 525/205; 525/132; 525/535; 525/204; 524/502; 524/500; 524/516; 525/190; 525/186; 525/199; 524/514

(57) ABSTRACT

Provided are chemically protective articles prepared in part from a hydrophilic polymer/barrier polymer blend film. In various embodiments, the chemically protective article is substantially impermeable to hazardous chemical agents, but is sufficiently permeable to water vapor that, if worn as protective apparel, it is both protective and comfortable to wear.

### FIELD OF THE INVENTION

The present invention relates to chemically protective articles prepared in part from continuous films comprising a miscible blend of a hydrophilic polymer and a barrier polymer. The articles are preferably substantially impermeable to hazardous chemical and biological agents, but sufficiently permeable to water vapor that, if worn as protective apparel, they are both protective and comfortable to wear.

### BACKGROUND

There is a growing need for structures that provide personal protection against toxic chemical and biological agents. It is known to devise structures that are impermeable to toxic chemical vapors and liquids, but, when used as apparel, such structures are typically also hot, heavy and uncomfortable to wear.

The degree of comfort offered by apparel worn as a protective suit is significantly affected by the amount of water vapor that can permeate through the fabric from which the suit is made. The human body continuously perspires water as a method for controlling body temperature. When a protective fabric hinders the loss of water vapor from the body, the transpirational cooling process is hindered, which leads to personal discomfort. When a protective suit allows little or no loss of water vapor, extreme heat stress or heat stroke can result in a short period of time. Hence, it is desirable that, in addition to offering the highest levels of protection against toxic chemicals and liquids, a practical chemical and biological protective suit have high water vapor transmission rates. It is also desirable that the appropriate protective structure be light in weight and offer the same high level of protection over a long period of time.

In an effort to increase the selectivity of polyetherimide membranes in separating toluene from methane and nitrogen from methane, Hying and Staude prepared miscible polyetherimide/poly(vinyl pyrrolidone) (PEI/PVP) blend membranes containing 5-30% PVP. A change in selectivity with respect to nitrogen/methane mixtures could not be observed when using blend membranes versus neat PEI. However, a striking nonlinear effect was observed with respect to toluene/methane selectivity; At 5% PVP the selectivity with respect to toluene reached a value of 1000 (Christian Hying and Eberhard Staude, Journal of membrane science 144(1-2), 251-257 (1998)).

The present invention provides articles for personal protection that comprise selectively permeable, continuous films comprising a miscible blend of a hydrophilic polymer and a barrier polymer and that, when worn as apparel, provide improved wearer comfort compared with impermeable articles.

### SUMMARY OF THE INVENTION

One aspect of the present invention is a chemically protective article that comprises a film comprising a miscible blend of a hydrophilic polymer and a barrier polymer. Chemically protective articles include items of apparel, shelters, and protective covers.

This and other aspects of the present invention will be apparent to one skilled in the art in view of the following description and the appended claims.

### BRIEF DESCRIPTION OF THE DRAWINGS

FIG. 1 is a schematic diagram showing the structure of one type of selectively permeable laminate according to an embodiment of the present invention.

### DETAILED DESCRIPTION

In the context of this disclosure, a number of terms shall be utilized.

The term “film” as used herein means a thin but discrete structure that moderates the transport of species in contact with it, such as gas, vapor, aerosol, liquid and/or particulates. A film may be chemically or physically homogeneous or heterogeneous. Films are generally less than about 0.25 mm thick.

The term “sheet” or “sheeting” as used herein means a film that is at least 0.25 mm thick.

The term “hydrophilic polymer” as used herein means a polymer absorbing greater than 0.5% of its weight of water within 24 hours, and greater than 4% at equilibrium, as determined by ASTM D570 testing. All water-soluble polymers are hydrophilic.

The term “soluble” as used herein denotes a material that forms a visibly transparent solution when mixed with a specified solvent. For example, a water-soluble material forms a transparent solution when mixed with water, while a water-insoluble material does not.

The term “barrier polymer” as used herein means a polymer with a moisture vapor transmission rate less than 10 kg/m²/24 h and a transport rate of materials harmful to human health that is low enough to prevent the occurrence of injury, illness or death. The desired transport rate depends on the nature and composition of the harmful material.

The term “(co)polymer” means homopolymer or copolymer.

The term “miscible blend” denotes an intimate mixture of at least two polymers that exhibits only one phase, as indicated by, for example, a single glass transition temperature.

The term “nonporous” as used herein denotes a material or surface that does not allow the passage of air other than by molecular diffusion.

The term “permeable” as used herein means allowing the passage of liquids and/or gases.

The term “selectively permeable” as used herein means allowing passage of certain species but acting as a barrier to others.

The term “laminate” as used herein means a multilayer structure comprising two or more parallel layers of material that are at least partially bonded to each other.

The term “substrate” as used herein means a material onto which a film is formed from solution.

The term “work device” as used herein denotes a substrate that is used only for film formation and does not subsequently become part of a laminate.

The term “harmful to human health” as used herein means causing injury and/or illness to humans as a consequence of acute or chronic exposure through dermal contact, ingestion, or respiration.

The term “structure”, as used herein with regard to structures fabricated from the hydrophilic polymer/barrier polymer blend film, includes single layers and multiple layers of hydrophilic polymer/barrier polymer blend films.

In preferred embodiments, the chemically protective articles are substantially impermeable to certain biological and/or chemical agents. It is often desirable that the films and laminates be at least 99% impermeable to certain agents, even up to 100% impermeable.

Because the hydrophilic polymer/barrier polymer blend films are selectively permeable, we have found that a protective article fabricated therefrom provides a protective barrier that inhibits the permeation through the article of chemical and biological agents that may be harmful to human health while maintaining sufficient water vapor permeability to maintain personal comfort when the protective article is an item of apparel.

### Hydrophilic Polymer

The protective articles disclosed herein contain a film comprising a miscible blend of a hydrophilic polymer/barrier polymer blend. The hydrophilic polymer can be present at 1 to 90 weight percent based on the weight of hydrophilic polymer plus barrier polymer. Examples of hydrophilic polymers include without limitation: poly(N-vinyl lactams) (e.g., poly(vinyl pyrrolidone) (“PVP”) and

polymers of N-vinyl substituted pyrrolidones (e.g., poly(N-vinyl-3, 3-dimethyl-1-pyrrolidone), poly(N-vinyl-4,4-dimethyl-2-pyrrolidone), poly(N-vinyl-3,4-dimethyl-2-pyrrolidone), poly(N-vinyl-3-ethyl-2-pyrrolidone), and poly(N-vinyl-3,5-dimethyl-2-pyrrolidone)), polyalkylene oxides (e.g., poly(propylene oxide) and poly(ethylene oxide)), poly(vinyl alcohol) (“PVOH”), ethylene-vinyl alcohol copolymers, poly(hydroxylalkyl methacrylate) (e.g., poly(hydroxyethyl methacrylate)), block poly(ether-co-amide), nylon 6, nylon 66, cellulose-based polymers (e.g., cellulose acetate and hydroxypropyl cellulose), polyacrylamide, poly(ethyl oxazoline), thermoplastic hydrophilic polyurethane; and hydrophilic copolymers thereof. Poly(vinyl pyrrolidone) (“PVP”) and poly(ethylene oxide) (“PEO”) are preferred hydrophilic polymers.

### Barrier Polymer

The term “barrier polymer” as used herein means a polymer with a moisture vapor transmission rate (“MVTR”) less than 10 kg/m²/24 h and a transport rate of materials harmful to human health that is low enough to reduce or, preferably, substantially eliminate the occurrence of injury and/or illness, or death. The desired transport rate will necessarily depend on the nature of the harmful material; for example, NFPA 1994, 2007 Revision requires <4.0 μg/cm² one hour cumulative permeation for mustard and <1.25 μg/cm² for Soman. Examples of barrier polymers suitable for use in the present invention include without limitation polysulfones (e.g., polyethersulfones, polyphenylsulfone, polysulfone); polyimides and polyetherimides; highly fluorinated polymers (e.g., homopolymers and copolymers of trifluoroethylene, hexafluoropropylene, monochlorotrifluoroethylene, dichlorodifluoroethylene, tetrafluoroethylene, vinylidene fluoride, and vinyl fluoride); butyl rubber; polychloroprene; vinylidene chloride (co)polymers; vinyl chloride (co)polymers; acrylic (co)polymers; acrylonitrile (co)polymers; polybenzazoles (e.g., poly(1,3-phenylenebisbenzimidazole) (“PBI”), poly(p-phenylene-2,6-benzobisoxazole) (“PBO”), poly(p-phenylenebisthiazole), and poly(pyridobisimidazole) (“PIPD”)); alkylene terephthalate (co)polymers (e.g., poly(ethylene terephthalate), poly(butylene terephthalate), and poly(n-propylene terephthalate)), liquid crystalline polyesters and polyesteramides, aramids (i.e., aromatic polyamides, wherein at least 85% of the amide (—CONH—) linkages are attached directly to two aromatic rings), and polycarbonates.

The present inventor has found that the blend of the barrier polymer and hydrophilic polymer unexpectedly exhibits higher selectivity than the barrier polymer alone. That is, the water vapor transport rate is significantly higher for the blend than for the barrier polymer alone, while there is little or no change in the permeability of the barrier polymer to harmful substances.

Depending on the polymers used, the blend can be prepared by dissolving the polymers in a common solvent or by melt mixing. Alternatively, the polymer blend can be precipitated from solution as a powder, which is subsequently melt processed to form a film. Some polymers are miscible in the melt but phase separate on cooling because one polymer crystallizes (see, e.g., D. Y. Yoon et al. on blends of polyvinylidene fluoride and PVP, in Makromolekulare Chemie, Macromolecular Symposia 50 (Bayreuth Polym. Mater. Res. Symp., 1991), 183-190 (1991)). In such cases, it is preferred that the blend be made in solution rather than by melt processing, to preserve miscibility.

When the polymers can be successfully melt processed together, the blend films can be made by typical melt mixing techniques. For instance, the polymers can be added to a single or twin screw extruder or a kneader or mixer such as a Brabender Plasticorder and mixed in the normal manner. After the materials are mixed, they can be formed (cut) into pellets or other particles suitable for feeding to a melt forming machine, for example, for making film or sheet.

When the blend film is to be prepared by casting from a solution, a common solvent for both the hydrophilic polymer and the barrier polymer is used. The solvent will depend on the nature of the polymers. Solvents typically used include, for example, dimethylacetamide, formamide, and N-methyl pyrrolidone. The appropriate concentration of the hydrophilic polymer and the barrier polymer in the casting solution will vary depending on how the solution is to be applied, and also on the molecular weights of the hydrophilic polymer and the barrier polymer, as a lower concentration may be desired for relatively high molecular weight polymer.

Different application methods work best with solutions of different viscosities, but typically, the solution will contain from about 1 to about 25 total combined wt % I of the hydrophilic polymer and the barrier polymer. The ratio of barrier polymer to hydrophilic polymer in solution is the ratio of barrier polymer to hydrophilic polymer desired in the blend film.

The film can include, in addition to the hydrophilic polymer and barrier polymer, additives to enhance various properties of the film, such as strength, flexibility, shrinkage upon drying, fire resistance and stability. Examples of such additives include without limitation: natural polymers, synthetic polymers, crosslinking agents, fillers, flame retardants, plasticizers, processing aids, tougheners, nucleants, colorants, antistats, surfactants, oil repellents, and stabilizers,(e.g., hydrolysis stabilization additives, thermal stabilizers, antioxidants, UV absorbers, UV stabilizers) Examples of fillers include without limitation glass (e.g., glass spheres, glass bubbles, glass fibers), clays (e.g., kaolin, sepiolite, attapulgite, and montmorillonite), carbon (e.g., carbon black, carbon fiber, carbon nanotubes), talc, calcium carbonate, wollastonite, and the like. Small amounts of such fillers, preferably less than 10 wt % (based on the total combined weight of hydrophilic polymer, barrier polymer, and all additives), can be used to increase thermal stability and modulus of the hydrophilic polymer/barrier polymer film. The total additives are preferably present at less than 50% by weight, based on the total combined weight of hydrophilic polymer, barrier polymer, and additives. Such additives can be added to the solution from which the film is to be cast. They can be soluble in the solution, or they can be present as dispersed insoluble material. When the film is made by melt processing, the additives can be physically mixed with the blend polymers before the melt mixing, added during the melt mixing (e.g., injected downstream during extrusion), or added to the melt-mixed blend in a subsequent, melt-forming step.

The hydrophilic polymer/barrier polymer film can be prepared by casting the solution directly onto a substrate that will be incorporated along with the film into a laminate. Alternatively, the solution can be cast onto a work device such as a smooth surface, such as glass or a polymer film (for example, polyester or PTFE films). If the film is cast onto a work device, the film is dried, detached and then incorporated into a laminate in a separate step.

The solution can be applied to a substrate by any of a variety of methods known in the art. For a small scale process, such as a laboratory test sample, the solution is typically applied using a doctor knife. Methods available to coat planar surfaces, which can have irregular surfaces, include without limitation spray coating, dip coating, and spin coating. In a commercial process, the solution could be applied to, e.g., traveling web. These and other suitable methods are described by Cohen and Gutoff in “Coating Processes” in the Kirk-Othmer Encyclopedia of Chemical Technology [John Wiley & Sons, 5^{th} edition (2004), Volume 7, Pages 1-35]. The method chosen will depend on several factors, such as the rheology of the solution to be applied, the desired wet film thickness, the speed of a substrate that is traveling, and the required coating accuracy as a percent of total thickness. The applied solution is then dried by any suitable method known in the art such as exposure to a hot air oven, air impingement drying, or radiative (e.g. infrared or microwave) drying (See, generally, Cohen and Gutoff, op. cit.). The result of the drying at this stage is a continuous film.

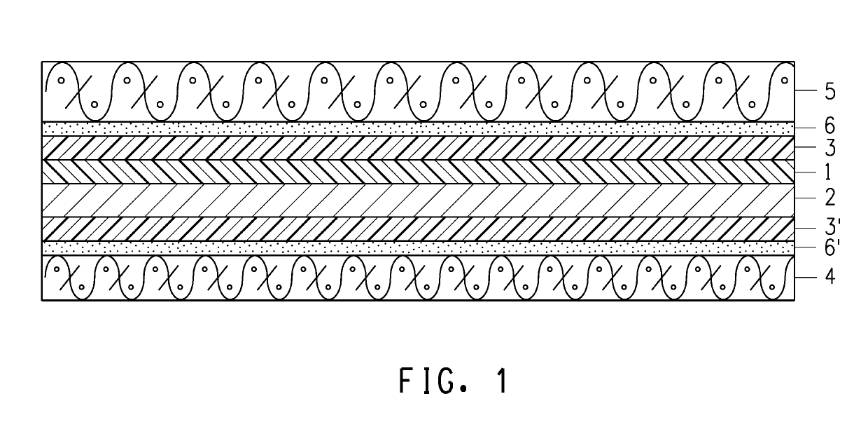

In one embodiment, the hydrophilic polymer/barrier polymer blend film is incorporated into a protective article by casting the film from solution directly onto a substrate to form a selectively permeable laminate, which will in turn be used to construct the article. In another embodiment, a pre-formed film (cast from solution or melt processed) is adhered to a layer, for example, polyurethane film, by thermal bonding, to form a selectively permeable laminate. In another embodiment, a laminate formed by casting the film from solution directly onto a substrate or by thermally bonding a pre-formed film to another layer is bonded to one or more layers of fabric by adhesive. The adhesive can be in the form of stripes or, preferably, dots, to provide a discontinuous layer of adhesive, in order not to block passage of gases and/or liquids through the selectively permeable laminate. FIG. 1 illustrates one embodiment of a selectively permeable laminate that could be used in, for example, a protective article of apparel. In the embodiment shown, the laminate contains the following elements: a blend film (1); a substrate to which the hydrophilic polymer blend film is adhered (2); additional layers (3, 3′); an inner liner (4); an outer shell (5) and adhesive. However, not all embodiments of the selectively permeable laminates contain all of the elements shown in FIG. 1.

Although a free-standing blend film can be incorporated into a protective article, it can, if desired, be adhered to a substrate. An adhesive may or may not be used, depending upon the substrate and the intended use. Thus, the term “adhered” includes application by methods such as gluing, suction, or fusing. Referring to FIG. 1, a hydrophilic polymer/barrier polymer blend film 1 can be prepared by casting a hydrophilic polymer/barrier polymer blend solution directly onto a substrate 2 that will be incorporated along with the film into a laminate. It can also be cast on a work surface like poly(ethylene terephthalate) film and coated with an additional layer or layers before or after the work surface is removed and discarded. In certain cases, the substrate onto which a hydrophilic polymer/barrier polymer blend can be prepared may itself be a continuous sheet or film, provided that the permeability of the substrate to water vapor under use conditions is adequate for the particular end use. For example, a garment would require much higher water vapor permeability than a tent or tarpaulin.

A suitable substrate will have at least one surface that is smooth, i.e., that is essentially without protrusions above the plane of the substrate that are higher than the desired thickness of the coating of hydrophilic polymer/barrier polymer blend that will be transformed into the film. Thus, a smoother substrate surface is required when the desired thickness of the coating of hydrophilic polymer/barrier polymer blend is 25 microns than when it is 100 microns.

A suitable substrate may be, for example, a film, a sheet whose permeability to water vapor under use conditions is adequate for the particular end use, a microporous membrane (i.e., one in which the typical pore size is about 0.1 to 10 micrometers in diameter), or an article prepared from any of the foregoing. It is preferred that the substrate surface that will be in contact with the hydrophilic polymer/barrier polymer blend film be both smooth and nonporous.

Suitable substrate materials include polymer films, including elastomers, glassy polymers, and semi-crystalline materials. Desirable substrate properties are flexibility, durability, good moisture transport and minimal or no shrinking or swelling in water. Examples of suitable substrate materials include but are not limited to ionomers, polyolefins, and fluoropolymers, as taught in U.S. patent application Ser. No. 11/593,958, which is hereby incorporated by reference in its entirety. An example of a suitable ionomer is a perfluorinated sulfonate polymer, such as a perfluorosulfonic acid tetrafluoroethylene copolymer.

In many end uses, particularly apparel, the continuous hydrophilic polymer/barrier polymer blend film (and its associated substrate, where present) is incorporated into a structure that includes an outer layer of material (an “outer shell,” 5 in FIG. 1) which is exposed to the environment and/or an inner liner 4.

The outer and inner materials can each be chosen for functional reasons such as ruggedness, ballistic resistance, and resistance to abrasion or tearing, as well as to impart a comfortable feel and a fashionable appearance to apparel. Colored and patterned materials can also be used as outer layers to introduce camouflage features in military applications. The outer shell and inner liner materials are typically fabric or microporous membranes.

Fabrics can be prepared from any synthetic or natural fiber appropriate for the specific end use in mind. Preferred fabrics can be prepared from aramids, nylons, polyesters, cotton, and blends comprising any of these, such as, for example, blends of nylon and cotton fibers (“NYCO”). The term “nylon” as used herein refers to polyamides other than aramids. An aramid is an aromatic polyamide, wherein at least 85% of the amide (—CONH—) linkages are attached directly to two aromatic rings.

Films and microporous membranes can be prepared from any synthetic or natural material appropriate for the specific end use in mind. Examples of films and microporous membranes that can be used as a component of inner liners or outer shells include without limitation expanded poly(tetrafluoroethylene) membranes such as those sold under the trademark GORE-TEX® (W. L. Gore & Associates, Inc., Newark, Del., USA); hydrophobic polyurethane microporous membranes (see, e.g., S. Brzeziński et al., Fibres & Textiles in Eastern Europe, January/December 2005, 13(6), 53-58); microporous (poly)propylene available from, e.g., 3M (St. Paul, Minn., USA) or Celgard LLC (Charlotte, N.C., USA); thin films of thermoplastic polyurethane such as those sold under the trademark Transport® Brand Film by Omniflex (Greenfield, Mass., USA); Pebax® polyether block amide by Arkema (Paris, France); and DuPont™ Active Layer, a polyester film available from E. I. du Pont de Nemours and Company (Wilmington, Del., USA).

Protective articles comprising the selectively permeable hydrophilic polymer/barrier polymer blend films disclosed herein can be assembled using any of the sewing, stitching, stapling or adhering operations, such as thermally pressing, known in the art, as described in U.S. patent application Ser. No. 11/593,958, herein incorporated by reference in its entirety.

Bonding between the film structure and the fabrics may be continuous or semi-continuous, for example, with adhesive dots or films. Alternatively, the bonding may be discontinuous, for example by sewing the edges together, an arrangement often referred to as a “hung liner”. Other methods of discontinuous bonding include the use of Velcro® strips or zippers.

The hydrophilic polymer/barrier polymer blend film is selectively permeable, having a Moisture Vapor Transmission Rate (“MVTR”) of at least 10, preferably at least 15 kg/m²/24 h, while the transport rate of materials harmful to human health is low enough to reduce or substantially eliminate the risk of the occurrence of injury, illness or death. The desired transport rate depends on the nature of the harmful material; for example, NFPA 1994, 2007 Revision, requires <4.0 μg/cm² one hour cumulative permeation for mustard and <1.25 μg/cm² for Soman. Examples of hydrophilic polymer/barrier polymer blend films described herein demonstrate low permeability to dimethylmethylphosphonate, a simulant for chemical warfare G-class nerve agents such as Soman, often as low as zero μg in 17 hours as described in the Examples below. Consequently, hydrophilic polymer/barrier polymer blend films may be used for the fabrication of, or as a component in, a variety of articles of manufacture, including articles of protective apparel, especially for clothing, garments or other items intended to protect the wearer or user against harm or injury as caused by exposure to toxic chemical and/or biological agents, including without limitation those agents potentially used in a warfighter environment and materials identified as “Toxic Industrial Chemicals” (TICs) or “Toxic Industrial Materials” (TIMs); see, for example, Guide for the Selection of Chemical and Biological Decontamination Equipment for Emergency First Responders, NIJ Guide 103-00, Volume I, published by the National Institute of Justice, U.S. Department of Justice (October 2001), herein incorporated by reference.

In one embodiment, an item of apparel including the hydrophilic polymer/barrier blend film described herein is useful to protect first responder personnel from known or unknown chemical or biological agents potentially encountered in an emergency response situation. In yet another embodiment, the item is intended to protect cleanup personnel from chemical or biological agents during a hazmat response situation. Such items of apparel include without limitation coveralls, protective suits, coats, jackets, limited-use protective garments, raingear, ski pants, gloves, socks, boots, shoe and boot covers, trousers, hoods, hats, masks and shirts.

In another embodiment, the film can be used as a component of a protective cover, such as a tarpaulin, or a collective shelter, such as a tent, to protect against chemical and/or biological warfare agents.

Furthermore, the films can be used in various medical applications as protection against toxic chemical and/or biological agents. In one embodiment, the films could be used as components of items of apparel for health care workers, such as medical or surgical gowns, gloves, slippers, shoe or boot covers, and head coverings.

### EXAMPLES

Specific embodiments of the present invention are illustrated in the following examples. The embodiments of the invention on which these examples are based are illustrative only, and do not limit the scope of the appended claims.

The meaning of the abbreviations used in the examples is as follows “ave” means average, “cm” means centimeter(s), “cP” means centipoise, “dL” means deciliter, “DMMP” means dimethylmethylphosphonate, “DMAc” means dimethylacetamide, “ePTFE” means expanded poly(tetrafluoroethylene), “g” means gram(s), “h” means hour(s), “kg” means kilogram(s), “m” means meter(s), “mg” means milligram(s), “μg” means microgram(s), “min” means minute(s), “mL” means milliliter(s), “μL” means microliter(s), “mm” means millimeter(s), “μm” means micrometer(s), “Mₙ” means number average molecular weight, “MVTR” means moisture vapor transmission rate, “M_{w}” means weight average molecular weight, “oz” means ounce(s), “Pa” means Pascal(s), “PBI” means poly(1,3-phenylenebisbenzimidazole), “PC” means poly(bisphenol A carbonate), “s” means second(s), “soln” means solution, “T_{g}” means glass transition temperature, “Tₘ” means melting temperature, “wt %” means weight percent, and “yd” means yard(s). Unless otherwise specified, the water used is distilled or deionized water.

MATERIALS All materials were used as received. The following polymers, which were described by the manufacturers as having the properties listed, were purchased as white powders from Sigma-Aldrich, Inc. (St. Louis, Mo., USA): polyvinylpyrrolidone with an average M_{w}=1,300,000 (determined by light scattering), melting point>300° C. and T_{g}=185° C.; poly(vinyl chloride) with average M_{w}=233,000 and average Mₙ=99,000, inherent viscosity of 1.4 dL/g, Tₘ=265° C. and T_{g}=81° C.; polyacrylonitrile with Tₘ=317° C. and T_{g}=85° C.; and poly(ethylene oxide) with an average M_{w}=1,000,000 and viscosity of 400-800 cP (0.4-0.8 Pa·s) at 25° C. (2% aqueous solution, measured with a Brookfield viscometer). Amber pellets of poly(bisphenol A carbonate) with an average M_{w}=64,000 (by GPC), Tₘ=267° C. and T_{g}=150° C. were also purchased from Aldrich. The following polymers were obtained form Solvay Advanced Polymers, L.L.C (Alpharetta, Ga., USA): Radel® R-5500 NT polyphenylsulfone with T_{g}=220° C. (amber pellets); Radel® H-2000P NT polyethersulfone with T_{g}=220° C. (white powder); Udel® P-3500 LCD MB7 polysulfone with T_{g}=190° C. (amber pellets); and Solef® 6020/1001 poly(vinylidene fluoride) with Tₘ=171° C. and T_{g}=−34° C. (white powder). Ultem® 1000 polyetherimide with T_{g}=217° C. was purchased from GE Plastics (Pittsfield, Mass., USA). Matrimid® 5218 polyimide with T_{g}>250° C. was purchased from Huntsman Advanced Materials (McIntosh, Ala., USA). P84® polyimide with T_{g}=315° C. was purchased from HP Polymer GMBH (Lenzing, Austria). PBI polymer ([poly(2,2′-(m-phenylene)]5,5′-bibenzimidazole) was obtained from PBI Performance Products, Inc (Charlotte, N.C., USA).

### Methods

### Standard Glass Plate Preparation.

All films were cast onto Pyrex® glass plates whose surfaces were rigorously cleaned with water and detergent, alcohol, strong base and strong acid before use. The following cleaning procedure was used for the examples, but other thorough cleaning protocols may also be suitable. A Pyrex® glass plate was washed with an aqueous solution of Micro-90 laboratory glassware cleaning agent, rinsed with water, and wiped dry with a paper towel. The plate was then cleaned with isopropanol and wiped dry. Next, a 10 wt % aqueous NaOH solution was coated on the plate, allowed to stand for five minutes, rinsed off with distilled water, and the plate was wiped dry. Finally, concentrated nitric acid was coated on the plate, allowed to stand for one minute, and rinsed off with distilled water. The plate was deemed ready for casting after a final rinse with distilled water and drying with soft paper towels.

### Moisture Vapor Transmission Rate (MVTR).

MVTR was measured by a method derived from the Inverted Cup method of MVTR measurement [ASTM E 96 Procedure BW, Standard Test Methods for Water Vapor Transmission of Fabrics (ASTM 1999)]. For each test, a vessel with an opening on top was charged with water and then the opening was covered first with a moisture vapor permeable (liquid impermeable) layer of expanded-PTFE film (“ePTFE”), then with the sample for which the MVTR was to be measured, and finally by a woven Nomex® aramid fabric overlayer [5.6 oz/yd² (0.19 kg/m²), treated with durable water repellent finish]. The three layers were sealed in place, inverted for 30 minutes to condition the layers, weighed to the nearest 0.001 g, and then contacted with a dry stream of nitrogen while inverted. After the specified time, the sample was re-weighed and the MVTR calculated (kg/m²/24 h) using the following equation:

MVTR=1/[(1/MVTR_{obs})−(1/MVTR_{mb})]

where MVTR_{obs} is observed MVTR of the experiment and MVTR_{mb} is the MVTR of the ePTFE moisture barrier (measured separately). The reported values are the average of results from four replicate samples.

### Dimethylmethylphosphonate (“DMMP”) Permeation.

DMMP was used as a relatively non-toxic simulant for chemical warfare G-class nerve agents. The DMMP permeation for the examples described below was carried out as follows: for each measurement, a vessel with an opening on top was charged with a measured amount of water containing 0.100% propylene glycol as an internal GC standard. The opening was covered with the sample film and a Nomex® woven aramid fabric overlayer [5.6 oz/yd² (0.19 kg/m²), treated with durable water repellent finish]. The layers were sealed in place and the fabric surface was treated with one 2 μL drop of DMMP (2.3 mg). The vessel was placed in a nitrogen-purged box for 17 h and then the DMMP concentration in the water was measured by GC analysis. Results are reported in μg of DMMP measured in the water after 17 h and are the average of five replicate samples. The DMMP was obtained from Aldrich Chemical Company (Milwaukee, Wis., USA) and used as received.

### Differential Scanning Calorimetry.

A TA Instruments 2920 Differential Scanning calorimeter (New Castle, Del., USA) was used to perform standard DSC runs at a heating rate of 10° C./min. A nitrogen purge was used for all experiments. The cell constant was obtained by calibration with an Indium standard, and the heat capacity calibration was performed with the sapphire disc supplied by TA Instruments. The temperature calibration was performed with different metal standards at the same heating rate. The weights of pans were selected to account for cell asymmetry. Sample weights were between 1 and 4 milligrams.

The T_{g}(s) of each material or blend was determined by analysis of the DSC output with the supplied software. The temperature of the glass transition was defined as the midpoint temperature, halfway between the onset temperature and the end temperature of the step transition region. The step height at the midpoint temperature was defined as the difference in heat flow values at the onset and the end tangents of the step transition region.

### Example 1

This example illustrates the preparation of blend films containing the barrier polymer Radel® R-5500 polyphenylsulfone and the hydrophilic polymer poly(vinyl pyrrolidone) (PVP). The moisture vapor transmission rates (MVTR) of the blend films increase as PVP concentration increases; films with ≧60% PVP are suitable for incorporation into a breathable protective garment. All the blend films provide protection against the chemical warfare agent simulant, DMMP.

Film 1A (100% Radel® R-5500 polyphenylsulfone: 0% PVP). A mixture of 7.5 g of Radel® R-5500 polyphenylsulfone pellets and 22.5 g of N,N-dimethylacetamide (“DMAc”) solvent in a 100 mL glass jar was stirred vigorously and heated to 90° C. on a hot plate for 60 min. Dissolution of the polymer pellets produced a viscous, yellow solution containing 25 wt % Radel® R-5500 polyphenylsulfone. A treated Pyrex® glass plate was placed on a hot plate preheated to 100° C., and the hot polymer solution was cast onto the hot glass using a 30 mil (0.76 mm), 4″-square (10 cm square) doctor knife. The resulting 4″×8″ (10 cm×20 cm) Film 1A remained on the hot plate at 100° C. for 1.5 h, then was cooled to room temperature and allowed to dry overnight under ambient conditions. Finally, Film 1A was hung vertically from a wire frame and dried in a 200° C. oven under nitrogen for 8 h to remove residual DMAc. The film was lifted from the glass plate by raising the edges with a sharp razor blade.

Film 1B (80% Radel® R-5500 polyphenylsulfone: 20% PVP). A mixture of 3.6 g of Radel® R-5500 polyphenylsulfone pellets, 0.9 g of PVP powder, and 25.5 g of DMAc solvent in a 100 mL glass jar was stirred vigorously and heated to 100° C. on a hot plate for 60 min. Dissolution of both polymers produced a viscous, yellow solution containing 15 wt % total polymer. The hot polymer solution was cast onto a 100° C. Pyrex® glass plate using the same procedure described for Film 1A, except that a 25 mil (0.64 mm) instead of a 30 mil (0.76 mm) doctor knife was used, and the film remained on the 100° C. hot plate for 1 h instead of 1.5 h after casting. The resulting Film 1B was dried and lifted from the plate in the same way as Film 1A.

Films 1C-1H were prepared using the same procedure described for Film 1B, except that the relative amounts of Radel® R-5500 polyphenylsulfone, PVP, and DMAc in the casting solution were varied as shown in Table 1.

TABLE 1
Radel ® R-5500 polyphenylsulfone/PVP casting solution composition

| | Radel ® R-5500 | Radel ® R-5500 | | DMAc | Total wt % |
|---|---|---|---|---|---|
| | polyphenylsulfone:PVP | polyphenylsulfone | PVP | solvent | polymer in |
| Film | ratio | (g) | (g) | (g) | soln |
| 1A | 100:0 | 7.50 | 0 | 22.5 | 25 |
| 1B | 80:20 | 3.60 | 0.90 | 25.5 | 15 |
| 1C | 65:35 | 2.93 | 1.57 | 25.5 | 15 |
| 1D | 50:50 | 2.25 | 2.25 | 25.5 | 15 |
| 1E | 40:60 | 2.40 | 3.60 | 34.0 | 15 |
| 1F | 30:70 | 1.80 | 4.20 | 34.0 | 15 |
| 1G | 25:75 | 1.00 | 3.00 | 22.7 | 15 |
| 1H | 17:83 | 1.00 | 5.00 | 34.0 | 15 |

MVTR and DMMP permeation through Films 1A-1H were measured using a Nomex® aramid fabric overlayer. The results are given in Table 2. DSC measurements of selected films showed a single, composition-dependent T_{g} for each film, indicating that Radel® R-5500 polyphenylsulfone and PVP are miscible in the films (Table 2).

TABLE 2
Radel ® R-5500 polyphenylsulfone/PVP blend film data

| | | | Thick- | | | Individual |
|---|---|---|---|---|---|---|
| | | | ness | | Ave. | DMMP |
| | % | T_{g} | (mil | MVTR | DMMP | values |
| Film | PVP | (° C.) | (μm)) | (kg/m²/24 h) | (μg in 17 h) | (μg in 17 h) |
| 1A | 0 | 224 | 1.8 (46) | 3.9 | 0 | 0, 0, 0, 0, 0 |
| 1B | 20 | — | 1.0 (25) | 4.8 | 0 | 0, 0, 0, 0, 0 |
| 1C | 35 | — | 1.0 (25) | 6.6 | 0 | 0, 0, 0, 0, 0 |
| 1D | 50 | 206 | 1.0 (25) | 8.8 | 0 | 0, 0, 0, 0, 0 |
| 1E | 60 | — | 1.0 (25) | 15.9 | 0 | 0, 0, 0, 0, 0 |
| 1F | 70 | — | 1.0 (25) | 23.7 | 0 | 0, 0, 0, 0, 0 |
| 1G | 75 | 198 | 1.0 (25) | 23.9 | 31 | 90, 19, 10, 20, 16 |
| 1H | 83 | 195 | 1.0 (25) | 26.8 | 0 | 0, 0, 0, 0, 0 |

### Example 2

This example illustrates that the water-soluble PVP component is not removed from a Radel® R-5500 polyphenylsulfone/PVP blend film, even after immersion in water for 3 h.

Film 2 was prepared using the same procedure as Film 1B, except that 1.2 g of Radel® R-5500 polyphenylsulfone, 3.1 g PVP powder, and 22.7 g of DMAc were used, giving a 28% Radel® R-5500 polyphenylsulfone/72% PVP blend, and the film remained on the 100° C. hot plate for 85 min rather than 60 min.

After drying, Film 2 was cut into two pieces, which were labeled Film 2A and Film 2B. MVTR and DMMP permeation through Film 2A were measured using a Nomex® aramid fabric overlayer. The results are given in Table 4. Film 2B was weighed to the nearest 0.001 g using an analytical balance and found to weigh 0.353 g. Film 2B was then placed into a room temperature water bath. At the time intervals shown in Table 3, the film was removed from the water bath, blotted with a Kimwipe® on both sides to remove excess water, and weighed using the same analytical balance. The weights at each time t are shown in Table 3. Film 2B was then air dried overnight at ambient temperature and weighed again, resulting in a final weight of 0.357 g. These results showed that no PVP was lost from the film upon immersion in water for 3 h. MVTR and DMMP permeation through Film 2B were measured using a Nomex® aramid fabric overlayer. The results are given in Table 4 and indicate that the water-immersed film has a similarly high MVTR to the non-immersed film, and remains a barrier to DMMP.

TABLE 3
Weight of water-immersed Radel ® R-5500
polyphenylsulfone/PVP blend Film 2B

| Time in Water | Film Weight |
|---|---|
| Bath (min) | (g) |
| 0 | 0.353 |
| 2 | 0.629 |
| 6 | 0.596 |
| 24 | 0.593 |
| 52 | 0.580 |
| 95 | 0.577 |
| 135 | 0.581 |
| 175 | 0.626 |
| 190 | 0.588 |
| Re-dried film | 0.357 |

TABLE 4
Radel ® R-5500 polyphenylsulfone/PVP blend
film data before and after water immersion

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 2A | 75 | 1.0 (25) | 24.6 | 4 | 17, 0, 0, 0, 0 |
| 2B | 75 | 1.0 (25) | 18.5 | 11 | 0, 56, 0, 0, 0 |

### Example 3

This example illustrates the preparation of blend films containing the barrier polymer Radel® H-1000 polyethersulfone and the hydrophilic polymer PVP. The MVTR of the blend films increase as PVP concentration increases; films with ≧50% PVP are suitable for incorporation into a breathable protective garment. All the blend films provide protection against the chemical warfare agent simulant, DMMP. Films 3A-3D were prepared using the same procedure described for Film 1B, except that the relative amounts of Radel® H-1000 polyethersulfone, PVP, and DMAc in the casting solution were varied as shown in Table 5.

TABLE 5
Radel ® H-1000 polyethersulfone/PVP casting solution composition

| | Radel ® H-1000 | Radel ® H-1000 | | DMAc | Total wt % |
|---|---|---|---|---|---|
| | polyethersulfone:PVP | polyethersulfone | PVP | solvent | polymer in |
| Film | ratio | (g) | (g) | (g) | soln |
| 3A | 100:0 | 7.5 | 0 | 22.5 | 25 |
| 3B | 50:50 | 3.0 | 3.0 | 34.0 | 15 |
| 3C | 25:75 | 1.0 | 3.0 | 22.7 | 15 |
| 3D | 17:83 | 1.0 | 5.0 | 34.0 | 15 |

MVTR and DMMP permeation through Films 3A-3D were measured using a Nomex® aramid fabric overlayer. The results are given in Table 6. DSC measurements on a second set of blend films (3B*-3D*) with the same compositions as films 3B-3D, cast using the same procedure, showed a single, composition-dependent T_{g} for each film, indicating that Radel® H-1000 polyethersulfone and PVP are miscible in the films (Table 6).

TABLE 6
Radel ® H-1000 polyethersulfone/PVP blend film data

| | | | Thick- | | | Individual |
|---|---|---|---|---|---|---|
| | | | ness | | Ave. | DMMP |
| | % | T_{g} | (mil | MVTR | DMMP | values |
| Film | PVP | (° C.) | (μm)) | (kg/m²/24 h) | (μg in 17 h) | (μg in 17 h) |
| 3A | 0 | — | 1.0 (25) | 1.7 | 0 | 0, 0, 0, 0, 0 |
| 3B | 50 | — | 1.0 (25) | 13.5 | 18 | 30, 14, 11, 14, 20 |
| 3C | 75 | — | 1.0 (25) | 24.3 | 29 | 21, 66, 24, 14, 19 |
| 3D | 83 | — | 1.0 (25) | 27.4 | 14 | 17, 17, 10, 7, 21 |
| 3B* | 50 | 219 | 2.2 (56) | 4.6 | 0 | 0, 0, 0, 0, 0 |
| 3C* | 75 | 208 | 2.5 (62) | 19.8 | 0 | 0, 0, 0, 0, 0 |
| 3D* | 83 | 208 | 2.4 (61) | 19.0 | 0 | 0, 0, 0, 0, 0 |

*Films 3B*-3D* were prepared separately in order to obtain T_{g} measurements; these films had the same composition and were cast using the same procedures as Films 3B-3D.

### Example 4

This example illustrates the preparation of blend films containing the barrier polymer Udel® P-3500 polysulfone and the hydrophilic polymer PVP. MVTR of the blend films increases as PVP concentration increases; films with ≧50% PVP are particularly suitable for incorporation into a breathable protective garment. All the blend films provide protection against the chemical warfare agent simulant, DMMP.

Films 4A-4D were prepared using the same procedure described for Film 1B, except that the relative amounts of Udel® P-3500 polysulfone, PVP, and DMAc in the casting solution were varied as shown in Table 7.

TABLE 7
Udel ® P-3500 polysulfone/PVP casting solution composition

| | Udel ® P-3500 | Udel ® P-3500 | | DMAc | Total wt % |
|---|---|---|---|---|---|
| | polysulfone:PVP | polysulfone | PVP | solvent | polymer in |
| Film | ratio | (g) | (g) | (g) | soln |
| 4A | 100:0 | 7.5 | 0 | 22.5 | 25 |
| 4B | 50:50 | 3.0 | 3.0 | 34.0 | 15 |
| 4C | 25:75 | 1.0 | 3.0 | 22.7 | 15 |
| 4D | 17:83 | 1.0 | 5.0 | 34.0 | 15 |

MVTR and DMMP permeation through Films 4A-4D were measured using a Nomex® aramid fabric overlayer. The results are given in Table 8.

TABLE 8
Udel ®P-3500 polysulfone/PVP blend film data

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 4A | 0 | 2.4 (61) | 5.5 | 0 | 0, 0, 0, 0, 0 |
| 4B | 50 | 1.0 (25) | 9.0 | 0 | 0, 0, 0, 0, 0 |
| 4C | 75 | 1.0 (25) | 34.0 | 38 | 31, 30, 40, 32, 59 |
| 4D | 83 | 1.0 (25) | 27.7 | 45 | 97, 50, 0, 30, 35 |

### Example 5

This example illustrates the preparation of blend films containing the barrier polymer Ultem® 1000 polyetherimide and the hydrophilic polymer PVP. MVTR of the blend films increases as PVP concentration increases; films with ≧50% PVP are suitable for incorporation into a breathable protective garment. All the blend films provide protection against the chemical warfare agent simulant, DMMP.

Films 5A-5D were prepared using the same procedure described for Film 1B, except that the relative amounts of Ultem® 1000 polyetherimide, PVP, and DMAc in the casting solution were varied as shown in Table 9.

TABLE 9
Ultem ® 1000 polyetherimide/PVP casting solution composition

| | Ultem ® 1000 | Ultem ® 1000 | | DMAc | Total wt % |
|---|---|---|---|---|---|
| | polyetherimide:PVP | polyetherimide | PVP | solvent | polymer in |
| Film | ratio | (g) | (g) | (g) | soln |
| 5A | 100:0 | 3.75 | — | 21.25 | 15 |
| 5B | 50:50 | 3.00 | 3.00 | 34.00 | 15 |
| 5C | 25:75 | 1.00 | 3.00 | 22.70 | 15 |
| 5D | 17:83 | 1.00 | 5.00 | 34.00 | 15 |

MVTR and DMMP permeation through Films 5A-5D were measured using a Nomex® aramid fabric overlayer. The results are given in Table 10.

TABLE 10
Ultem ® 1000 polyetherimide/PVP blend film data

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 5A | 0 | 1.2 (30) | 2.4 | 0 | 0, 0, 0, 0, 0 |
| 5B | 50 | 1.0 (25) | 25.2 | 50 | 15, 19, 188, 13, 14 |
| 5C | 75 | 1.0 (25) | 29.1 | 0 | 0, 0, 0, 0, 0 |
| 5D | 83 | 1.0 (25) | 46.3 | 0 | 0, 0, 0, 0, 0 |

### Example 6

This example illustrates the preparation of blend films containing a barrier polyimide (Matrimid® polyimide) and the hydrophilic polymer PVP. MVTR of the blend films increases as PVP concentration increases; films with ≧50% PVP are suitable for incorporation into a breathable protective garment. All the blend films provide protection against the chemical warfare agent simulant, DMMP.

Films 6A-6D were prepared using the same procedure described for Film 1B, except that the relative amounts of Matrimid® polyimide, PVP, and DMAc in the casting solution were varied as shown in Table 11.

TABLE 11
Matrimid ® polyimide/PVP casting solution composition

| | Matrimid ® | Matrimid ® | | DMAc | Total wt % |
|---|---|---|---|---|---|
| | polyimide:PVP | polyimide | PVP | solvent | polymer in |
| Film | ratio | (g) | (g) | (g) | soln |
| 6A | 100:0 | 3.0 | 0 | 17.0 | 15 |
| 6B | 50:50 | 3.0 | 3.0 | 34.0 | 15 |
| 6C | 25:75 | 1.0 | 3.0 | 22.7 | 15 |
| 6D | 17:83 | 1.0 | 5.0 | 34.0 | 15 |

MVTR and DMMP permeation through Films 6A-6D were measured using a Nomex® aramid fabric overlayer. The results are given in Table 12.

TABLE 12
Matrimid ® polyimide/PVP blend film data

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 6A | 0 | 1.6 (41) | 0.7 | 0 | 0, 0, 0, 0, 0 |
| 6B | 50 | 1.0 (25) | 16.6 | 3 | 0, 0, 0, 0, 16 |
| 6C | 75 | 1.0 (25) | 25.2 | 5 | 0, 0, 0, 0, 26 |
| 6D | 83 | 1.0 (25) | 31.5 | 0 | 0, 0, 0, 0, 0 |

### Example 7

This example illustrates the preparation of blend films containing a barrier polyimide (P84® polyimide) and the hydrophilic polymer PVP. MVTR of the blend films increases as PVP concentration increases; films with ≧5% PVP are suitable for incorporation into a breathable protective garment. All the blend films provide protection against the chemical warfare agent simulant, DMMP.

Films 7A-7D were prepared using the same procedure described for Film 1B, except that the relative amounts of P84®, PVP, and DMAc in the casting solution were varied as shown in Table 13.

TABLE 13
P84 ® polyimide/PVP casting solution composition

| | P84 ® | P84 ® | | DMAc | Total wt % |
|---|---|---|---|---|---|
| | polyimide:PVP | polyimide | PVP | solvent | polymer |
| Film | ratio | (g) | (g) | (g) | in soln |
| 7A | 100:0 | 4.5 | 0 | 22.5 | 15 |
| 7B | 50:50 | 3.0 | 3.0 | 34.0 | 15 |
| 7C | 25:75 | 1.0 | 3.0 | 22.7 | 15 |
| 7D | 17:83 | 1.0 | 5.0 | 34.0 | 15 |

MVTR and DMMP permeation through Films 7A-7D were measured using a Nomex® aramid fabric overlayer. The results are given in Table 14. DSC measurements of a second set of blend films (7B*-7D*) with the same compositions as films 7B-7D, cast using the same procedure, showed a single, composition-dependent T_{g} for each film, indicating that P84® polyimide and PVP are miscible in the films (Table 14).

TABLE 14
P84 ®/PVP blend film data

| | | | Thick- | | | Individual |
|---|---|---|---|---|---|---|
| | | | ness | | Ave. | DMMP |
| | % | T_{g} | (mil | MVTR | DMMP | values |
| Film | PVP | (° C.) | (μm)) | (kg/m²/24 h) | (μg in 17 h) | (μg in 17 h) |
| 7A | 0 | — | 2.0 (51) | 0.5 | 0 | 0, 0, 0, 0, 0 |
| 7B* | 50 | 227 | 1.0 (25) | 15.2 | 2 | 0, 0, 0, 0, 5 |
| 7C* | 75 | 210 | 1.0 (25) | 29.6 | 3 | 0, 0, 0, 0, 7 |
| 7D* | 83 | 206 | 1.0 (25) | 32.1 | 15 | 0, 0, 0, 0, 34 |

*Tg measurements were made on a different set of films than MVTR and DMMP permeation measurements, but both sets of films had the same composition and were cast using the same procedure.

### Example 8

This example illustrates the preparation of blend films containing the barrier polymer polyacrylonitrile (PAN) and the hydrophilic polymer PVP. MVTR of the blend films increases as PVP concentration increases; films with ≧50% PVP are suitable for incorporation into a breathable protective garment. All the blend films provide protection against the chemical warfare agent simulant, DMMP.

Films 8A-8D were prepared using the same procedure described for Film 1B, except that the relative amounts of PAN, PVP, and DMAc in the casting solution were varied as shown in Table 15.

TABLE 15
PAN/PVP casting solution composition

| | | | | DMAc | Total wt % |
|---|---|---|---|---|---|
| | PAN:PVP | PAN | PVP | solvent | polymer |
| Film | ratio | (g) | (g) | (g) | in soln |
| 8A | 100:0 | 4.5 | 0 | 25.5 | 15 |
| 8B | 50:50 | 3.0 | 3.0 | 34.0 | 15 |
| 8C | 25:75 | 1.0 | 3.0 | 22.7 | 15 |
| 8D | 17:83 | 1.0 | 5.0 | 34.0 | 15 |

MVTR and DMMP permeation through Films 8A-8D were measured using a Nomex® aramid fabric overlayer. The results are given in Table 16.

TABLE 16
PAN/PVP blend film data

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 8A | 0 | 0.8 (20) | 8.8 | 12 | 10, 52, 0, 0, 0 |
| 8B | 50 | 1.0 (25) | 28.8 | 4 | 0, 0, 0, 0, 19 |
| 8C | 75 | 1.0 (25) | 27.0 | 12 | 0, 0, 0, 0, 58 |
| 8D | 83 | 1.0 (25) | 17.9 | 21 | 0, 0, 0, 0, 107 |

### Example 9

This example illustrates the preparation of blend films containing the barrier polymer poly(vinyl chloride) (PVC) and the hydrophilic polymer PVP. MVTR of the blend films increases as PVP concentration increases; films with ≧50% PVP are suitable for incorporation into a breathable protective garment. All the blend films provide protection against the chemical warfare agent simulant, DMMP.

Films 9A-9D were prepared using the same procedure described for Film 1B, except that DMF was used as the solvent rather than DMAc, and the relative amounts of PVC, PVP, and DMF in the casting solution were varied as shown in Table 18. Also, the films were dried at 160° C. rather than 200° C. because a lower boiling solvent was used.

TABLE 18
PVC/PVP casting solution composition

| | | | | DMF | Total wt % |
|---|---|---|---|---|---|
| | PVC:PVP | PVC | PVP | solvent | polymer |
| Film | ratio | (g) | (g) | (g) | in soln |
| 9A | 100:0 | 4.5 | 0 | 25.5 | 15 |
| 9B | 50:50 | 3.0 | 3.0 | 34.0 | 15 |
| 9C | 25:75 | 1.0 | 3.0 | 22.7 | 15 |
| 9D | 17:83 | 1.0 | 5.0 | 34.0 | 15 |

MVTR and DMMP permeation through Films 9A-9D were measured using a Nomex® aramid fabric overlayer. The results are given in Table 19.

TABLE 19
PVC/PVP blend film data

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 9A | 0 | 1.0 (25) | 1.2 | 7 | 16, 35, 0, 0, 0 |
| 9B | 50 | 1.0 (25) | 14.7 | 0 | 0, 0, 0, 0, 0 |
| 9C | 75 | 1.0 (25) | 26.4 | 0 | 0, 0, 0, 0, 0 |
| 9D | 83 | 1.0 (25) | 32.7 | 0 | 0, 0, 0, 0, 0 |

### Example 10

This example illustrates the preparation of blend films containing the barrier polymer poly(bisphenol A carbonate) (PC), and the hydrophilic polymer PVP. MVTR of the blend films increases as PVP concentration increases; films with ≧75% PVP are suitable for incorporation into a breathable protective garment. All the blend films provide protection against the chemical warfare agent simulant, DMMP.

Films 10A-10C were prepared using the same procedure described for Film 1B, except that the relative amounts of PC, PVP, and DMAc in the casting solution were varied as shown in Table 20. Also note that attempts to make a 100% PC film (without PVP) resulted in a very brittle film that could not be removed intact from the glass casting plate.

TABLE 20
PC/PVP casting solution composition

| | | | | DMAc | Total wt % |
|---|---|---|---|---|---|
| | PC:PVP | PC | PVP | solvent | polymer |
| Film | ratio | (g) | (g) | (g) | in soln |
| 10A | 50:50 | 3.0 | 3.0 | 34.0 | 15 |
| 10B | 25:75 | 1.0 | 3.0 | 22.7 | 15 |
| 10C | 17:83 | 1.0 | 5.0 | 34.0 | 15 |

MVTR and DMMP permeation through Films 10A-100 were measured using a Nomex® aramid fabric overlayer. The results are given in Table 21.

TABLE 21
PC/PVP blend film data

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 10A | 50 | 1.0 (25) | 7.0 | 0 | 0, 0, 0, 0, 0 |
| 10B | 75 | 1.0 (25) | 26.9 | 15 | 57, 0, 18, 0, 0 |
| 10C | 83 | 1.0 (25) | 23.2 | 16 | 0, 0, 40, 0, 41 |

### Example 11

This example illustrates the preparation of blend films containing the barrier polymer Solef® 6020 poly(vinylidene fluoride) (PVDF) and the hydrophilic polymer PVP. MVTR of the blend films increases as PVP concentration increases. All the blend films provide protection against the chemical warfare agent simulant, DMMP.

Films 11A-11C were prepared using the same procedure described for Film 1B, except that the relative amounts of Solef® 6020 poly(vinylidene fluoride), PVP, and DMAc in the casting solution were varied as shown in Table 22. The 100% Solef® 6020 poly(vinylidene fluoride) film was baked horizontally at 200° C. rather than vertically.

TABLE 22
Solef ®6020 poly(vinylidene fluoride)/PVP
casting solution composition

| | Solef ® 6020 | | | | |
|---|---|---|---|---|---|
| | poly(vinylidene | Solef ® 6020 | | DMAc | Total wt % |
| | fluoride):PVP | poly(vinylidene | PVP | solvent | polymer in |
| Film | ratio | fluoride) (g) | (g) | (g) | soln |
| 11A | 100:0 | 7.5 | 0 | 22.5 | 25 |
| 11B | 50:50 | 3.0 | 3.0 | 34.0 | 15 |
| 11C | 25:75 | 1.0 | 3.0 | 22.7 | 15 |

MVTR and DMMP permeation through Films 11A-11C were measured using a Nomex® aramid fabric overlayer. The results are given in Table 23.

TABLE 23
Solef ® 6020 poly(vinylidene fluoride)/PVP blend film data

| | | Thick- | | | Individual |
|---|---|---|---|---|---|
| | | ness | | Ave. | DMMP |
| | % | (mil | MVTR | DMMP | values |
| Film | PVP | (μm)) | (kg/m²/24 h) | (μg in 17 h) | (μg in 17 h) |
| 11A | 0 | 0.8 (20) | 4.2 | 10 | 0, 50, 0, 0, 0 |
| 11B | 50 | 0.8 (20) | 23.8 | 42 | 68, 37, 64, 39, 0 |
| 11C | 75 | 0.6 (15) | 37.0 | 21 | 22, 0, 0, 56, 28 |

### Example 12

This example illustrates the preparation of blend films containing the barrier polymer Radel® R-5500 polyphenylsulfone and the hydrophilic polymer poly(ethylene oxide) (PEO). MVTR of the blend films increases as PEO concentration increases. All the blend films provide protection against the chemical warfare agent simulant, DMMP.

Films 12A-12C were prepared using the same procedure described for Film 1B, except that the relative amounts of Radel® R-5500 polyphenylsulfone, PEO, and DMAc in the casting solution were varied as shown in Table 24.

TABLE 24
Radel ® R-5500/PEO casting solution composition

| | Radel ® R-5500 | Radel ® R-5500 | | DMAc | Total wt % |
|---|---|---|---|---|---|
| | polyphenylsulfone:PEO | polyphenylsulfone | PEO | solvent | polymer in |
| Film | ratio | (g) | (g) | (g) | soln |
| 12A | 100:0 | 7.5 | 0 | 22.5 | 25 |
| 12B | 75:25 | 1.0 | 5.0 | 34.0 | 15 |
| 12C | 50:50 | 1.0 | 3.0 | 22.7 | 15 |

MVTR and DMMP permeation through Films 12A-12C were measured using a Nomex® aramid fabric overlayer. The results are given in Table 25.

TABLE 25
Radel ® R-5500 polyphenylsulfone/PEO blend film data

| | | Thick- | | | Individual |
|---|---|---|---|---|---|
| | | ness | | Ave. | DMMP |
| | % | (mil | MVTR | DMMP | values |
| Film | PEO | (μm)) | (kg/m²/24 h) | (μg in 17 h) | (μg in 17 h) |
| 12A | 0 | 1.8 (46) | 3.9 | 0 | 0, 0, 0, 0, 0 |
| 12B | 75 | 1.0 (25) | 5.7 | 0 | 0, 0, 0, 0, 0 |
| 12C | 50 | 3.0 (76) | 15.4 | 6 | 0, 21, 2, 0, 8 |

### Example 13

This example illustrates the preparation of blend films containing the barrier polymer polybenzimidazole (PBI) and the hydrophilic polymer

PVP. MVTR of the blend films increases as PVP concentration increases. All the blend films provide protection against the chemical warfare agent simulant, DMMP.

Films 13A (100% PBI: 0% PVP). A mixture of 0.90 g of PBI powder and 24.5 g of N-methyl pyrrolidone (NMP) solvent in a 200 mL round bottom flask was stirred vigorously and refluxed at 180° C. for 2 h in an oil bath. Dissolution of PBI produced a brown solution containing 3.5 wt % polymer. To improve film coating on the Pyrex® glass plate, 5 mL (4.7 g) of DMAc solvent was then added to the hot solution, giving a solution containing 3.0 wt % polymer. The hot polymer solution was cast onto a 100° C. Pyrex® glass plate using the same procedure described for Film 1A, except that a 50 mil (1.02 mm) instead of a 30 mil doctor knife was used, and the film remained on the 100° C. hot plate for 1 h instead of 1.5 h after casting. The resulting Film 13A was dried and lifted from the plate in the same way as Film 1A.

Films 13B-13D were prepared using the same procedure described for Film 13A, except that the polymer solutions (containing both PBI and PVP in NMP) were refluxed overnight and the relative amounts of PBI, PVP, and NMP in the casting solution were varied as shown in Table 26. DMAc was not added to Film 13D prior to casting.

TABLE 26
PBI/PVP casting solution composition

| | | | | NMP | Total wt % |
|---|---|---|---|---|---|
| | PBI:PVP | PBI | PVP | solvent | polymer |
| Film | ratio | (g) | (g) | (g) | in soln |
| 13A | 100:0 | 0.9 | 0 | 24.5 | 3.5 |
| 13B | 50:50 | 2.0 | 2.0 | 22.9 | 15 |
| 13C | 25:75 | 1.0 | 3.0 | 22.7 | 15 |
| 13D | 17:83 | 1.0 | 5.0 | 34.0 | 15 |

MVTR and DMMP permeation through Films 13A-13D were measured using a Nomex® aramid fabric overlayer. The results are given in Table 27.

TABLE 27
PBI/PVP blend film data

| | | Thick- | | | |
|---|---|---|---|---|---|
| | | ness | | Ave. | |
| | % | (mil | MVTR | DMMP | DMMP values |
| Film | PVP | (μm)) | (kg/m²/24 h) | (μg in 17 h) | (μg in 17 h) |
| 13A | 0 | 0.4 (10) | 1.8 | 0 | 0, 0, 0, 0, 0 |
| 13B | 50 | 1.0 (25) | 11.3 | 0 | 0, 0, 0, 0, 0 |
| 13C | 75 | 2.8 (71) | 21.2 | 34 | 53, 0, 0, 11, 106 |
| 13D | 83 | 2.6 (66) | 23.1 | 18 | 18, 8, 0, 4, 61 |

### Example 14

This example demonstrates preparation of a hydrophilic polymer/barrier polymer blend film by melt processing. Powders of the barrier polymer poly(bisphenol A carbonate) (PC) and the hydrophilic polymer poly(ethylene oxide) are mixed in proportions ranging from 0 to 40% PEO by weight. The polymers are melt mixed to form a miscible blend using a Brabender Electronic Plasticorder Torque Rheometer at about 225° C. and 75 revolutions per minute for about five minutes under a nitrogen purge. Film of the blend material is made by compression-molding using a hot press at 220-235° C. for about four minutes followed by a fast cooling to room temperature. The PEO-containing films demonstrate higher MVTR than the PC control, with the 40% PEO demonstrating the highest MVTR, while DMMP transmission is essentially unchanged by the addition of PEO.

1. A chemically protective article that comprises a film comprising a miscible blend of a hydrophilic polymer and a barrier polymer.

2. The chemically protective article according to claim 1 wherein the hydrophilic polymer is selected from the group consisting of poly(N-vinyl lactam), poly(alkylene oxide), poly(vinyl alcohol), ethylene-vinyl alcohol copolymers, poly(hydroxylalkyl methacrylate), block poly(ether-co-amide), nylon 6, nylon 66, cellulose-based polymers, polyacrylamide, poly(ethyl oxazoline), thermoplastic hydrophilic polyurethane; and hydrophilic copolymers thereof.

3. The chemically protective article according to claim 2 wherein the poly(N-vinyl lactam) is poly(vinyl pyrrolidone).

4. The chemically protective article of claim 2 wherein the poly(alkylene oxide) is poly(ethylene oxide).

5. The chemically protective article according to claim 1 wherein the barrier polymer is selected from the group consisting of polysulfones; polyimides and polyetherimides; highly fluorinated polymers; butyl rubber; polychloroprene; vinylidene chloride (co)polymers; vinyl chloride (co)polymers; acrylic (co)polymers; acrylonitrile (co)polymers; polybenzazoles; alkylene terephalate (co)polymers; liquid crystalline polyesters and polyesteramides; aramids; and polycarbonates.

6. The chemically protective article according to claim 1 wherein the ratio of the hydrophilic polymer to the barrier polymer is from about 1:99 to about 90:10 by weight.

7. The chemically protective article according to claim 1 wherein the hydrophilic polymer/barrier polymer blend film further comprises one or more members selected from the group consisting of natural polymers, synthetic polymers, crosslinking agents, fillers, flame retardants, plasticizers, processing aids, tougheners, nucleants, colorants, antistats, surfactants, oil repellents and stabilizers, and wherein the film comprises at least 50% hydrophilic polymer/barrier polymer blend by weight.

8. The chemically protective article according to claim 1 wherein said article is selected from the group consisting of items of apparel, shelters, and protective covers.

9. An item of apparel according to claim 8 wherein the item of apparel is selected from the group consisting of coveralls, protective suits, coast, jackets, limited-use protective garments, raingear, ski pants, gloves, socks, boots, shoe or boot covers, trousers, hoods, hats, masks, shirts and medical garments.

10. A medical garment according to claim 9 wherein the medical garment is selected from the group consisting of medical or surgical gowns, gloves, slippers, shoe or boot covers, and head coverings.
